(19) United States
(12) Patent Application Publication
(10) Pub. No.: US 2026/0057323 A1
(43) Pub. Date: Feb. 26, 2026

(54) TASK PROCESSING METHOD, ELECTRONIC DEVICE, AND STORAGE MEDIUM

(71) Applicant: Beijing Lenovo Software Ltd., Beijing (CN)

(72) Inventors: Meng WU, Beijing (CN); Xinyu ZHOU, Beijing (CN); Gang MA, Beijing (CN)

(21) Appl. No.: 19/302,917

(22) Filed: Aug. 18, 2025

(30) Foreign Application Priority Data
Aug. 20, 2024 (CN) 202411147185.9

(51) Int. Cl. G06Q 10/0631; G06F 16/35

(52) U.S. Cl. CPC G06Q 10/06316; G06F 16/35

(57) ABSTRACT

A task processing method includes obtaining a target task, determining a plurality of intelligent agents with different processing capabilities based on the target task, using the plurality of intelligent agents to process the target task to obtain a plurality of first results, each intelligent agent outputting a first result, and processing the plurality of first results in a first processing mode or a second processing mode based on a number of different first results to obtain a final result of the target task.

### CROSS-REFERENCES TO RELATED APPLICATION

This application claims priority to Chinese Patent Application No. 202411147185.9 filed on Aug. 20, 2024, the entire content of which is incorporated herein by reference.

### FIELD OF TECHNOLOGY

The present disclosure relates to the field of task processing technology and, more specifically, to a task processing method and device.

### BACKGROUND

At present, many electronic devices are locally equipped with data processing models based on artificial intelligence technology. Electronic devices can use these models to analyze and process user input instructions to complete corresponding tasks such as analyzing specific documents or generating documents based on user instructions.

The processing power of a data processing model is positively correlated with the number of parameters in the model. That is, the larger the model is and the more parameters it contains, the stronger the processing power of the model is. However, the more model parameters there are, the more computing resources the electronic device consumes when running the model. Therefore, due to the limitation of the local computing resources of the electronic device, the number of parameters of the model configured locally on the device is limited, and the demonstrated processing capacity is insufficient to meet the needs of users.

### SUMMARY

One aspect of the present disclosure provides a task processing method. The method includes obtaining a target task, determining a plurality of intelligent agents with different processing capabilities based on the target task, using the plurality of intelligent agents to process the target task to obtain a plurality of first results, each intelligent agent outputting a first result, and processing the plurality of first results in a first processing mode or a second processing mode based on a number of different first results to obtain a final result of the target task.

Another aspect of the present disclosure provides an electronic device. The electronic device includes one or more processors; and one or more memories coupled to the one or more processors and storing a plurality of computer instructions that, when being executed, cause the one or more processors to perform: obtaining a target task; determining a plurality of intelligent agents with different processing capabilities based on the target task; using the plurality of intelligent agents to process the target task to obtain a plurality of first results, each intelligent agent outputting a first result; and processing the plurality of first results in a first processing mode or a second processing mode based on a number of different first results to obtain a final result of the target task.

Another aspect of the present disclosure provides a non-transitory computer readable storage medium containing computer instructions that, when being executed, cause at least one processor to perform: obtaining a target task; determining a plurality of intelligent agents with different processing capabilities based on the target task; using the plurality of intelligent agents to process the target task to obtain a plurality of first results, each intelligent agent outputting a first result; and processing the plurality of first results in a first processing mode or a second processing mode based on a number of different first results to obtain a final result of the target task.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a task processing method according to some embodiments of the present disclosure.

FIG. 2 is a flowchart of the task processing method according to some embodiments of the present disclosure.

FIG. 3 is a schematic diagram of processing first results based on a first processing mode according to some embodiments of the present disclosure.

FIG. 4 is a schematic diagram of processing the first results based on a second processing mode according to some embodiments of the present disclosure.

FIG. 5 is a schematic diagram of the task processing method according to some embodiments of the present disclosure.

FIG. 6 is a schematic structural diagram of a task processing device according to some embodiments of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

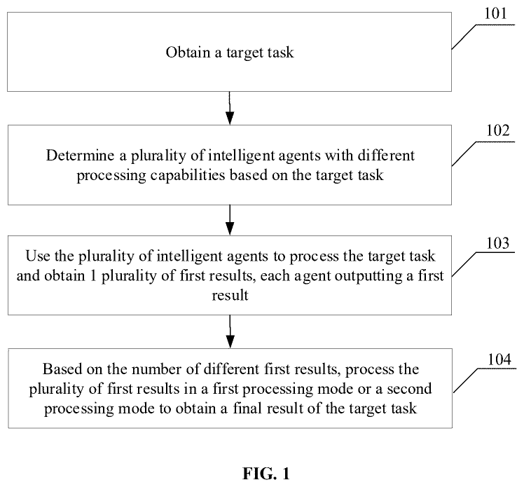

FIG. 1 is a flowchart of a task processing method according to some embodiments of the present disclosure. The method will be described in detail below.
101, obtaining a target task.

The target task may be any task that needs to be processed using a target model, for example, a long text reading task, a knowledge extraction task, a product development task, etc. The target model may be a neural network model, a deep learning model or other similar models implemented based on artificial intelligence technology. For the structure and principle of the target model, reference can be made to the relevant technologies in the field of artificial intelligence, which will not be described in detail here.

The obtained target task may include the task data required to process the target task. For example, for a long text reading task, the corresponding task data may include the long text data that needs to be read; for a knowledge extraction task, the task data may include several text documents from which knowledge needs to be extracted; for a product development task, the task data may include data describing product requirements and product application scenarios.

When implementing the process at 101, the electronic device may obtain the target task based on the user's operation, for example, download or read the long text data from the storage medium based on the user's operation, and obtain the long text reading task based on the long text data.
102, determining a plurality of intelligent agents with different processing capabilities based on the target task.

To process the target task from different perspectives to obtain processing results from different perspectives of the target task, in the process at 102, a plurality of intelligent agents with different processing capabilities where each capability is related to the target task can be determined.

In some embodiments, the electronic device may determine the plurality of intelligent agents using different determination methods.

In the first determination method, the intelligent agents may be determined by dividing the target task into multiple subtasks and determining a plurality of intelligent agents whose processing capabilities match the subtasks. In this way, the electronic device can use the target model to divide the target task into several subtasks.

For example, if the target task is a long text reading task, the electronic device can use the target model to divide the long text reading task into multiple subtasks such as detail analysis task, main idea extraction task, information reasoning task, fact determination task, problem solving task, etc. After dividing the target task into subtasks, for each subtask, the electronic device uses the target model to determine the processing capability required to process the subtask, thereby determining an intelligent agent with the processing capability.

In the example above, the target model can determine that the processing capability required for the detail analysis task is to identify text details related to the specific problem to be solved in the long text data, such as phrases and sentences related to the problem. For the information reasoning task, the target model can determine the required processing capability to perform logical reasoning on the existing information in the long text data to obtain new information required to solve specific problems. For fact determination task, the target model can determine the required processing capability to combine known information and inferred information to determine whether the information recorded in the long text data is correct. For the main idea extraction task, the target model can determine the required processing capability to summarize and generalize the long text data and determine the theme of the long text data. For problem solving task, the target model can determine the required processing capability to determine solutions or suggestions related to the problem to be solved based on the content of the long text data.

After determining the processing capability required for each subtask, the electronic device can determine the intelligent agent corresponding to each subtask based on the processing capabilities.

In the second determination method, the intelligent agents may be determined by determining multiple roles related to the target task and determining the intelligent agents with the corresponding processing capabilities and matching roles. In this way, the electronic device can use the target model to analyze the different roles that can handle the target task when the target task is manually processed, and then determine the processing capabilities of each role, and finally determine the intelligent agents with processing capabilities that match each role.

For example, if the target task is a product development task, the target model can be used to determine that the target task requires personnel from multiple roles, such as product manager, designer, development engineer, test engineer, and product operation, to handle the target task. Then, the processing capability of the product manager role can be determined based on the target model, thereby determining an intelligent agent with the processing capability of the product manager role corresponding to the product manager role. Similarly, the agent corresponding to the development engineer role, the agent corresponding to the test engineer role, and the agent corresponding to the product operation role can be determined based on the target model.

In another example, if the target task is a long text reading task, the writer role, editor role, and reviewer role related to the task can be determined, thereby determining the agent corresponding to the writer role, the agent corresponding to the editor role, and the agent corresponding to the reviewer role.

In some embodiments, the electronic device may also determine the intelligent agents using a combination of determination methods. For example, three intelligent agents with different processing capabilities may be determined based on the first determination method, and three intelligent agents with different processing capabilities may be determined based on the second determination method, and subsequent steps may be performed based on these six agents with different processing capabilities.

In some embodiments, the electronic device may also determine the intelligent agents required in the process at 102 based on the user operation. For example, the user can input the description of the processing capability of each agent, and the electronic device can interpret the description based on the target model, and then determine the agent with the corresponding processing capability based on the description. Alternatively, the electronic device can display a plurality of commonly used intelligent agents with different processing capabilities, and the user can select a plurality of intelligent agents from the displayed intelligent agents. Then, the electronic device can determine the plurality of intelligent agents selected by the user as the plurality of intelligent agents used to process the target task in the process at 102.
103, using the plurality of intelligent agents to process the target task and obtain a plurality of first results, each agent outputting a first result.

The processing capability of each agent can be provided by the target model deployed locally on the electronic device. After determining the plurality of intelligent agents with different processing capabilities in the process at 102, the target model can be used to generate capability description information corresponding to each intelligent agent, where the capability description information represents the processing capability of the corresponding intelligent agent.

Continue with the above example, for intelligent agent 1 corresponding to the information reasoning task, the capability description information may include “the intelligent agent is able to perform logical reasoning on the existing information in the long text data to obtain new information required to solve a specific problem”. For intelligent agent 1 corresponding to the fact determination task, the capability description information may include “the intelligent agent is able to combine known information and inferred information to determine whether the information recorded in the long text data is correct”.

When any intelligent agent is needed to process the target task, the capability description information corresponding to the intelligent agent may be input into the target model as a prompt such that the target model can process the target task based on the processing capability corresponding to the intelligent agent, thereby obtaining the first result output by the intelligent agent.

Continue with the above example, when intelligent agent 1 corresponding to the information reasoning task is used to process the target task, the capability description information corresponding to the intelligent agent and the task data of the target task can be input into the target model. The target model can process the task data based on its ability to logically infer new information based on the prompts of the capability description information to obtain the first result output by intelligent agent 1. When intelligent agent 2 corresponding to the fact determination task is used to process the target task, the capability description information corresponding to the intelligent agent and the task data of the target task can be input into the target model. The target model can process the task data based on its ability to determine the authenticity of the information included in the task data based on the prompts of the capability description information to obtain the first result output by intelligent agent 2.
104, based on the number of different first results, processing the plurality of first results in a first processing mode or a second processing mode to obtain a final result of the target task.

In some embodiments, the first results output by the plurality of intelligent agents may be the same or different. For example, if four first results were output by four intelligent agents in the process at 103, the first result of intelligent agent 1 may be the same as the first result of intelligent agent 2, the first result of intelligent agent 3 may be the same as the first result of intelligent agent 4, the first result of intelligent agent 1 may be different from the first result of intelligent agent 3, and the first results of any two intelligent agents from intelligent agent 1 to intelligent agent 4 may be different from each other.

In the process at 104, the electronic device may compare the obtained first results to determine the number of different first results output by the intelligent agents respectively, and use different processing modes to process these first results again based on the number of different first results to obtain the final result of the target task.

For example, after comparison, if it is determined that there are only two different first results in the process at 103, the electronic device can process the first results in the first processing mode to obtain the final result of the target task. After comparison, if it is determined that three or more different first results are obtained in the process at 103, the electronic device can process the first results in the second processing mode to obtain the final result of the target task.

In some embodiments, the corresponding may directly compare whether the contents of the first results output by the two intelligent agents are consistent. If the contents are completely consistent, the two first results can be determined as the same first result. If the contents are not completely consistent, the two first results can be determined as two different first results.

In some embodiments, the electronic device can also determine the similarity of the first results output by two intelligent agents based on the target model. If the similarity between the two first results is greater than a specific similarity threshold, the two first results can be determined as being the same first result; if the similarity between the two first results is not greater than the similarity threshold, the two first results can be determined as being two different first results.

Consistent with the present disclosure, when processing the target task, a plurality of intelligent agents with different processing capabilities can be used to process the target task respectively, and then different processing models can be used to further process the plurality of first results based on the number of different first results output by the intelligent agents. In this way, the different processing capabilities of intelligent agents can be combined to obtain the final result of the target task. The technical solutions provided in the present disclosure can combine different processing capabilities to process the target task using multiple intelligent agents, and obtain more accurate processing results without increasing the model parameters of the model.

In some embodiments, the electronic device may repeatedly perform the process of processing the plurality of first results in the first processing mode or the second processing mode based on the number of different first results, until a final result of the target task that meets the convergence condition is obtained.

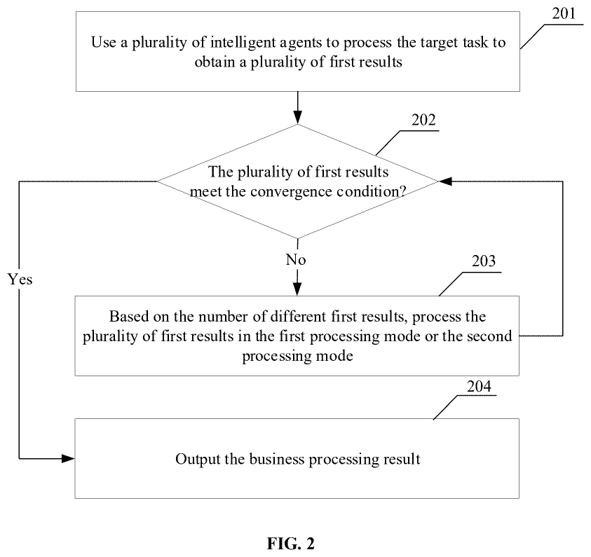

FIG. 2 is a flowchart of the task processing method according to some embodiments of the present disclosure. The method will be described in detail below.
201, using a plurality of intelligent agents to process the target task to obtain a plurality of first results.
202, determining whether the plurality of first results meet the convergence condition; if not, perform the process at 203; otherwise, perform the process at 204.

The convergence condition can be set as needed. For example, the convergence condition can be set as the plurality of first results currently obtained belonging to the same first result. That is, assume that three first results are obtained in the process at 201, if each of the first results is the same as or highly similar to the other two first results, the three first results can be determined as belonging to the same first result and meet the convergence condition. If each of the first results is different from the other two first results or has a low similarity, the three first results can be determined as not belonging to the same first result and the convergence condition is not met.

In some embodiments, the convergence condition may be set to the number of iterations being greater than or equal to a set number of iteration threshold. In some embodiments, the number of iterations may be defined as the number of times the process at 203 is performed.

In some embodiments, the convergence condition may also include the above two conditions, that is, as long as any one of the above two conditions is met, the plurality of first results obtained can be determined as meeting the convergence condition, and process at 204 can be performed. If both of the above two conditions are not met, the plurality of first results obtained can be determined as not meeting the convergence condition, and the process at 203 can be executed.
203, based on the number of different first results, processing the plurality of first results in the first processing mode or the second processing mode.

In the process at 203, the electronic device can select the first processing mode or the second processing mode based on the number of different first results, and then based on the selected processing mode, use the plurality of intelligent agents to process the currently obtained first results again to obtain the plurality of results output by the plurality of intelligent agents.

In some embodiments, if the number of different first results is equal to 2, the electronic device may select the first processing mode, and process the plurality of first results obtained using the plurality of intelligent agents in the first processing mode. If the number of different first results is greater than 2, the electronic device may select the second processing mode, and process the plurality of first results obtained using the plurality of intelligent agents in the second processing mode.

After performing the process at 203, the electronic device can obtain a plurality of results output by the plurality of intelligent agents. At this time, the electronic device can use these results as new first results and perform the process at 202. If these new first results still do not meet the convergence condition, the electronic device can perform the process at 203 again, and so on.

For example, after performing the process at 201, the electronic device obtains a first batch of first results and determines that the first batch of first results do not meet the convergence condition. At this time, the electronic device performs the process at 203 for the first time, processes first batch of first results based on the plurality of intelligent agents in the corresponding processing mode, and obtains a second batch of first results. After the determination in the process at 202, if it is determined that the second batch of first results also do not meet the convergence condition, the electronic device can perform the process at 203 for the second time. The electronic device processes the second batch of first results based on the plurality of intelligent agents in the corresponding processing mode, and obtains a third batch of first results. Assume that the third batch of first results meet the convergence condition, the electronic device can perform the process at 204 to determine the final result of the target task based on the third batch of first results.
204, obtaining the final results of the target task that meets the convergence condition.

In the process at 204, if the same results are obtained through one or more processes at 203, any one of the results can be selected as the final result of the target task. If two or more different results are still obtained through one or more processes at 203, the electronic device can evaluate the accuracy of each result based on the target model and take the result with higher accuracy than the other results as the final result. Alternatively, the electronic device may determine the number of votes for each result and determine the result with the highest number of votes as the final result. The number of votes for a result can be understood as the number of intelligent agents that output this result. For example, if there are five agents, three of which output the same first result, then the number of votes for this first result is 3.

Consistent with the present disclosure, iterative processing can be performed on the outputs of the plurality of intelligent agents, which is beneficial in improving the accuracy of the final result.

In some embodiments, the first processing mode can be considered as a confrontation mode between multiple intelligent agents. When processing multiple first results in the first processing mode, the electronic device can use multiple intelligent agents to confront each other to obtain the final result of the target task.

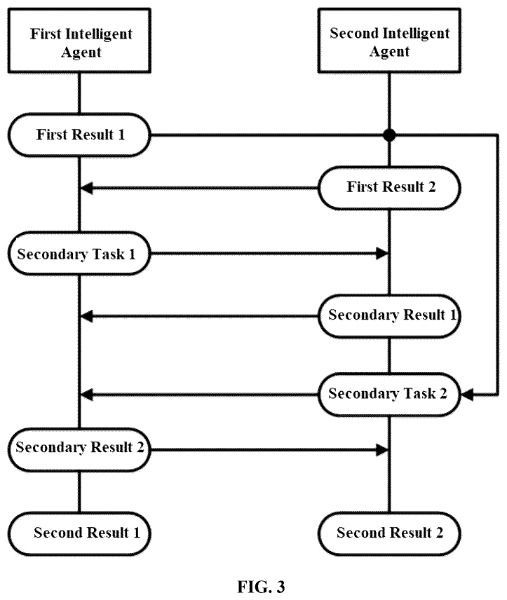

FIG. 3 is a schematic diagram of processing the first results based on the first processing mode according to some embodiments of the present disclosure.

As shown in FIG. 3, in the first processing mode, any two intelligent agents with different first output results can be randomly selected as a first intelligent agent and a second intelligent agent.

For example, assume that there are 5 intelligent agents, namely intelligent agent 1 to intelligent agent 5, and assume that the first results output by intelligent agent 1 to intelligent agent 3 belong to the same result, and the first results output by intelligent agent 4 and intelligent agent 5 belong to the same result and are different from the results of intelligent agents 1 to 3. In this case, intelligent agent 1 can be selected as the first intelligent agent, and intelligent agent 4 can be selected as the second intelligent agent.

After determining the first intelligent agent and the second intelligent agent, as shown in FIG. 3, the two intelligent agents can be used to process each other's first results to obtain the corresponding secondary tasks. That is, the first intelligent agent can be used to process the first result output by the second intelligent agent (e.g., the first result 2 in FIG. 3) to obtain the secondary task of the first intelligent agent (e.g., the secondary task 1 in FIG. 3), and the second intelligent agent can be used to process the first result output by the first intelligent agent (e.g., the first result 1 in FIG. 3) to obtain the secondary task of the second intelligent agent (e.g., the secondary task 2 in FIG. 3).

In some embodiments, when using the first intelligent agent and the second intelligent agent to process each other's first result, specific prompt information can be input to the two intelligent agents to make the intelligent agents output specific secondary tasks.

For example, the input prompt information may be prompt information instructing the intelligent agent to question the first input result. Through this prompt information, the first intelligent agent can output a secondary task 1 questioning the correctness of the first result 2, and the second intelligent agent can output a secondary task 2 questioning the correctness of the first result 1.

The content of the prompt information is not limited in the present disclosure. As an example, the prompt information instructing the intelligent agent to question the first input result may include the following content:
Challenge_prompt=” “Opponent has come up with different answer. Please maintain your perspective and find evidence from the document to challenge and question the opponent, output starts with [Challenge].
[Opponent's answer]
{opponent}
Output use following format:
[Challenge]

In some embodiments, after obtaining the secondary tasks output by the two intelligent agents, the two intelligent agents can be used to process the secondary tasks output by each other respectively to obtain the secondary results corresponding to the secondary tasks.

For example, in FIG. 3, the second intelligent agent can be used to process the secondary task of the first intelligent agents (i.e., secondary task 1) to obtain the secondary result of the second intelligent agent (i.e., secondary result 1), and the first intelligent agent can be used to process the secondary task of the second intelligent agent (i.e., secondary task 2) to obtain the secondary result of the first intelligent agent (i.e., secondary result 2).

In some embodiments, each intelligent agent may process the input secondary tasks based on its own output results and the task data of the target task. Based on the above example, the first intelligent agent can process the secondary task 2 based on the first result 1 and the task data of the target task to obtain the corresponding secondary result 2, and the second intelligent agent can process the secondary task 1 based on the first result 2 and the task data of the target task to obtain the corresponding secondary result 1.

In some embodiments, when processing a secondary task, the prompt information for indicating a processing method of the secondary task may be input to the intelligent agent such that the intelligent agent can process the input secondary task based on the specified processing method.

For example, when the first intelligent agent is used to process the second intelligent agent's secondary task 2, the input prompt information can instruct the first intelligent agent to answer the question in the secondary task 2 to illustrate the correctness of the first intelligent agent's first result 1. When the second intelligent agent is used to process the second intelligent agent's secondary task 1, the input prompt information can instruct the second intelligent agent to answer the question in the secondary task 1 to illustrate the correctness of the second intelligent agent's first result 2.

The content of the prompt information is not limited in the present disclosure. As an example, when using an intelligent agent to process a secondary task, the following prompt information can be input into the intelligent agent to cause the intelligent agent to answer questions raised in the secondary task.
rebute prompt=” “Opponent has raised doubts about you. Please maintain your own viewpoint and find evidence from the document to refute the Opponent's viewpoint, output starts with [Response].
[Response]
[Opponent's challenge]
[opponent]
Output use following format
[Response]
Your response to opponent's challenge based on the document “ ”.

After obtaining the secondary result, the first intelligent agent can be used to process the secondary result of the second intelligent agent (i.e., secondary result 1 in FIG. 3) and the plurality of first results to obtain the second result of the first intelligent agent, and the second intelligent agent can be used to process the secondary result of the first intelligent agent (i.e., secondary result 2 in FIG. 3) and the plurality of first results to obtain the second result of the second intelligent agent.

In some embodiments, the first intelligent agent and the second intelligent agent may combine the secondary results output by each other and the first results of both intelligent agents to process the target task again to obtain their respective second results.

In some embodiments, when the two intelligent agents obtain their respective second results in the above manner, the two intelligent agents can also refer to other interaction contents between the first intelligent agents and the second intelligent agent.

For example, the first intelligent agent can process the target task again based on the secondary result 1 of the second intelligent agent and the first results of both intelligent agents to obtain the second result. In addition, the first intelligent agent can also process the target task again to obtain a second result based on multiple contents such as the secondary task 1 output by the first intelligent agent, the secondary task 2 output by the second intelligent agent, the secondary result 2 output by the first intelligent agent, the secondary result 1 of the second intelligent agent and the first results of both intelligent agents.

In some embodiments, when an intelligent agent is used to obtain the corresponding second result, specific prompt information can also be input to the intelligent agent to instruct the intelligent agent to process the target task again based on the content of the interaction. As an example, the prompt information input to the intelligent agent in this case may include the following content.
reanswer_prompt=″″ Please read the document again, consider it comprehensively, consider the previous discussion comprehensively, and come up with your final answer, starts with [Answer], and explaining the reasons, starts with [Reasoning]
Output uses following format:
[Answer]
Answer number (Select one option).
[Reasoning]

Find the most relevant content to answer the question, explain the reasoning process, and state the reason for choosing that answer.

In some embodiments, after obtaining the second results of the two intelligent agents, the final result of the target task can be determined based on the second result of the first intelligent agent and the second result of the second intelligent agent.

After obtaining the second result, as shown in FIG. 2, whether the two second results meet the convergence condition can be determined. If the convergence condition is met, the final result of the target task can be determined using the process at 204. If the convergence condition is not met, the two second results can be determined as a new batch of first results, and then the new batch of first results can be processed again based on the first processing mode until a result that meets the convergence condition is obtained after a certain processing.

In some embodiments, the second processing mode can be considered as a cooperation mode between multiple intelligent agents. When processing multiple first results based on the second processing mode, the electronic device can process the target task through the cooperation of multiple intelligent agents to obtain the final result of the target task.

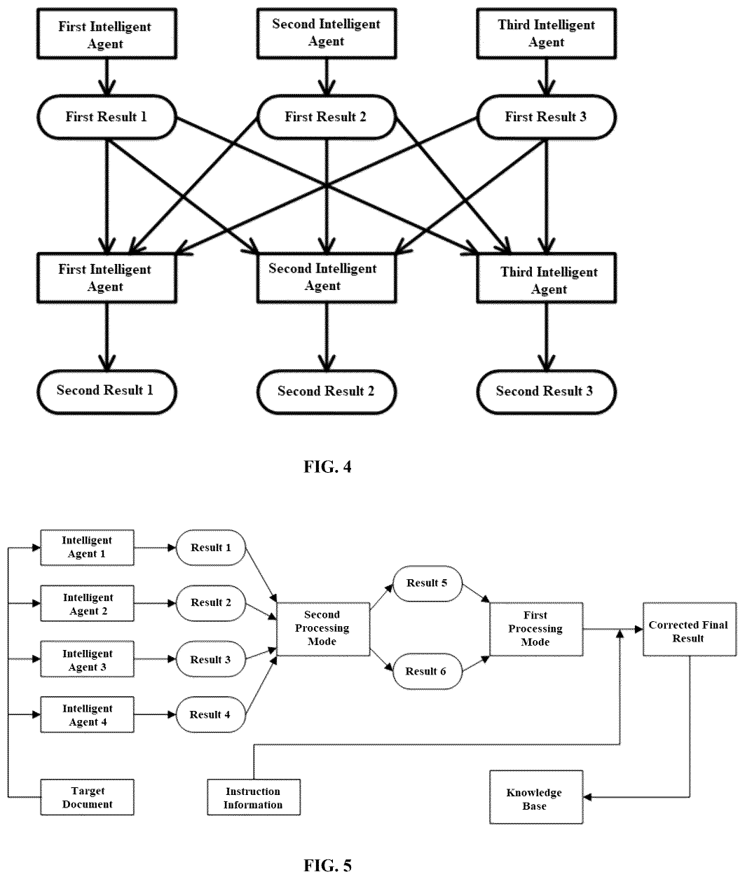

FIG. 4 is a schematic diagram of processing the first results based on the second processing mode according to some embodiments of the present disclosure.

When processing a plurality of first results in the second processing mode, each first result may be input into each intelligent agent such that each intelligent agent can be used to process the plurality of first results to obtain the second result of the intelligent agent.

Take FIG. 4 as an example, assume that three intelligent agents are determined based on the target task, namely the first intelligent agent, the second intelligent agent and the third intelligent agent. After processing the target task, the three intelligent agents output three different first results, which are from first result 1 to first result 3. Since the number of different first results is greater than 2, the second processing mode can be used for processing.

At this time, the first result 1 to first result 3 can be input into the first intelligent agent at the same time to cause the first intelligent agent to process the target task again based on the first result 1 to first result 3, and obtain the second result 1; the first result 1 to first result 3 can be input into the second intelligent agent at the same time to cause the second intelligent agent to process the target task again based on the first results to obtain the second result 2; the first result 1 to first result 3 can be input into the third intelligent agent at the same time to cause the third intelligent agent to process the target task again based on the first results to obtain the second result 3.

In some embodiments, when multiple first results are input into an intelligent agent, specific prompt information can be input into the intelligent agent to instruct the intelligent agent to process the target task again based on the input first results. As an example, the prompt information input to the intelligent agent may include the following content.
cooperate_prompt=″″{other_answer}

Firstly, based on the answer and reasons of the above people, check whether there are and omissions or error in your answer and reasons, check whether there are any error in the reasons and answer of others, and your demonstration needs to be supported by the article. Output starts with [Demonstration].

Finally, answer again use answer number. Output starts with [Answer]. For example: [Answer] 3″″.

After obtaining the plurality of second results, the final result of the target task may be determined based on the plurality of second results.

Consistent with the method of determining the final result in the first processing mode described above, after obtaining a plurality of second results in the second processing mode, whether the plurality of second results obtained meet the convergence condition can be determined based on the process at 202 shown in FIG. 2. If the convergence condition is met, the final result of the target task can be determined using the process at 204. If the convergence condition is not met, the plurality of second results obtained can be determined as a new batch of first results, and then the process at 203 can be performed again to process the new batch of first results again based on the first processing mode or the second processing mode until a result that meets the convergence condition is obtained after a certain processing.

In some embodiments, after obtaining the final result, the instruction information corresponding to the target task can be determined using the following process to improve the accuracy of processing other subsequent tasks:

Obtaining a benchmark result corresponding to the target task, and determining the instruction information based on the benchmark result and the final result, the instruction information being used to instruct the intelligent agent to process the next target task.

Different methods can be used to obtain the benchmark result. One of the methods to obtain a benchmark result is to display the final result and the results output by each intelligent agent before the final result is obtained to the user, and prompt the user to select the result that best meets the user's needs, and determine the result selected by the user as the benchmark result. Alternatively, the user may be prompted to correct the final output result, and the result corrected by the user can be determined as the benchmark result.

Another method to obtain the benchmark result is to use a large model containing more parameters to process the target task and determine the result output by the large model as the benchmark result. For example, assume that the intelligent agents described above all process target tasks based on a target model with fewer model parameters deployed locally on the electronic device. When the benchmark result is obtained, the electronic device can upload the target task to the server, use the large model deployed by the server containing a large number of model parameters to process the target task, and receive the processing result of the large model fed back by the server as the benchmark result.

After obtaining the benchmark result, the benchmark result and the final result can be input into each intelligent agent, and the intelligent agent can be used to compare the differences between the two, and determine the instruction information based on the differences between the benchmark result and the final result.

In some embodiments, after obtaining the benchmark result, the final result may be identified first. If the similarity between the benchmark result and the final result is high, the final result may be considered as the correct answer. In this case, the instruction information can be determined without considering the benchmark result and the final result. If the similarity between the benchmark result and the final result is low, the final result may be considered to be a wrong answer. In this case, the intelligent agent can be used to determine the instruction information based on the benchmark result and the final result.

In the case where some instruction information has been obtained, after obtaining the target task, the intelligent agent may refer to the obtained instruction information to process the target task.

One of the methods of processing the target task using the instruction information includes inputting the obtained instruction information to the intelligent agent together with the task data in the form of prompts when the intelligent agent is processing the target task such that the intelligent agent can process the target task with reference to the input instruction information.

Another method of processing the target task using the instruction information includes, after obtaining the final result of the target task based on the method described above, inputting the final result and the instruction information into the intelligent agent, and using the intelligent agent to correct the obtained final result based on the instruction information to obtain the corrected final result. In this case, the electronic device may output the corrected final result to the user.

In some embodiments, when there is a large amount of instruction information, in order to improve the efficiency of the intelligent agent in processing tasks based on the instruction information, multiple pieces of instruction information can be summarized using the following process:

Classifying the multiple pieces of instruction information into multiple categories, and processing each category of instruction information instruction to obtain the instruction information summary corresponding to each category, the guidance information summary being used to instruct the intelligent agent to process the next target task belonging to the corresponding category.

In some embodiments, the instruction information may be classified based on the type of target task when the instruction information is obtained. For example, the instruction information obtained when processing the long text reading task can be classified as one category, the instruction information obtained when processing the knowledge extraction task can be classified as one category, and the instruction information obtained when processing the product development task can be classified as one category.

After the classification is completed, for each category, multiple pieces of instruction information belonging to the category can be input into the target model. The target model can delete the redundant content in the instruction information of this category and merge the duplicate content to generate a summary of the instruction information of this category.

The process of summarizing the instruction information can be performed regularly at a certain period, such as once a week, once every 10 days, etc.

In some embodiments, when processing any target task, whether there is a instruction information summary corresponding to the category can be determined first. If there is an instruction information summary of the category, the intelligent agent can refer to the instruction information summary of the category to process the target task.

For example, if a long text reading task is obtained and needs to be processed, whether there is an instruction information summary corresponding to the long text reading task can be determined. If there is an instruction information summary corresponding to the long text reading task, the intelligent agent can refer to the instruction information summary to process the obtained long text reading task.

The method of processing the target task with reference to the instruction information summary is consistent with the method of processing the target task with reference to the instruction information described above, and will not be repeated here.

In some embodiments, when multiple intelligent agents are used to process a target task and multiple first results are obtained, specific prompt information can be input to the agents using the following process to improve the processing efficiency of the task:

Obtaining the task instruction information corresponding to the target task, and inputting the task instruction information and the task data of the target task into each intelligent agent to obtain the first result output by each intelligent agent.

In some embodiments, the task instruction information may include the instruction information or instruction information summary described above. The task instruction information may also be input by the user when obtaining the target task. In this case, the task instruction information can indicate the processing method of the target task.

The task processing method in this embodiment can be used to process various tasks. As an example, it can be used to process a knowledge extraction task.

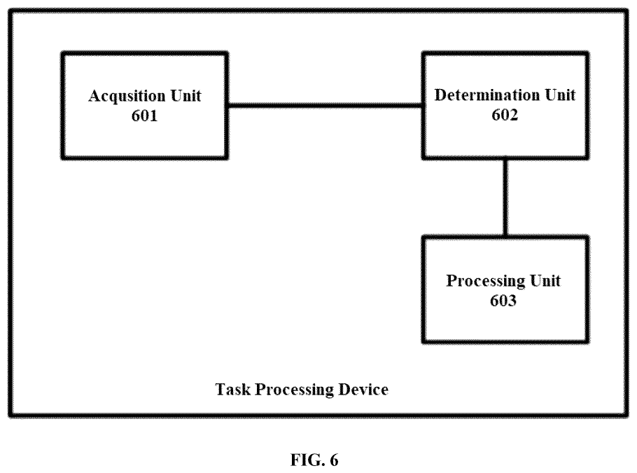

Referring to FIG. 5, when processing a knowledge extraction task, the target document from which knowledge needs to be extracted can be first obtained as task data, and then four intelligent agents with different processing capabilities can be determined, namely intelligent agent 1 to intelligent agent 4.

Intelligent agent 1 to intelligent agent 4 can be used to perform the knowledge extraction tasks on the target document respectively to obtain the first results of each intelligent agent. As shown in FIG. 5, the first results of intelligent agent 1 to intelligent agent 4 are result 1 to result 4 respectively.

After comparing the first results, it is determined that result 1 to result 4 are different from each other, that is, there are 4 different first results. At this point, result 1 to result 4 are processed in the second processing mode.

When processing in the second processing mode, result 1 to result 4 can be input to intelligent agent 1 to intelligent agent 4 respectively such that each of intelligent agent 1 to intelligent agent 4 can process the target task again based on result 1 to result 4.

After processing in the second processing mode, the four intelligent agents output two different second results respectively. The second results output by intelligent agent 1 and intelligent agent 2 are both result 5, and the second results output by intelligent agent 3 and intelligent agent 4 are both result 6.

Since there are two different results, result 5 and result 6 can be considered as the two first results of the second batch, intelligent agents 1 is determined as the first intelligent agent shown in FIG. 3, intelligent agent 4 is determined as the second intelligent agent shown in FIG. 3, and results 5 and 6 are processed in the first processing mode described above. In this case, result 5 corresponds to the first result 1 in FIG. 3, and result 6 corresponds to the first result 2 in FIG. 3.

After processing in the first processing mode, the second result output by the first intelligent agent is the same as the second result output by the second intelligent agent, therefore, the second result is determined as meeting the convergence condition, and the obtained second result is determined as the final result. Then, the first intelligent agent or the second intelligent agent is used to correct the final result based on the pre-acquired instruction information to obtain the corrected final result, and the corrected final result is stored in the knowledge base as the knowledge extracted from the target document.

Embodiments of the present disclosure also provide a task processing device. FIG. 6 is a schematic structural diagram of a task processing device according to some embodiments of the present disclosure.

Referring to FIG. 6, the task processing device includes an acquisition unit 601, a determination unit 602 and a processing unit 603.

In some embodiments, the acquisition unit 601 may be configured to obtain the target task.

In some embodiments, the determination unit 602 may be configured to determine a plurality of intelligent agents with different processing capabilities based on the target task.

In some embodiments, the processing unit 603 may be configured to use the plurality of intelligent agents to process the target task and obtain 1 plurality of first results, each agent outputting a first result, and process the plurality of first results based on the first processing mode or the second processing mode based on the number of different first results to obtain the final result of the target task.

In some embodiments, when processing the first results in the first processing mode or the second processing mode based on the number of different first results to obtain the final result of the target task, the processing unit 603 may be configured to process the first results in the first processing mode or the second processing mode multiple times based on the number of different first results until the final result of the target task that meets the convergence condition is obtained.

In some embodiments, when processing the first results in the first processing mode or the second processing mode based on the number of different first results to obtain the final result of the target task, the processing unit 603 may be configured to process the first results in the first processing mode to obtain the final result of the target task when there are two different first results, and process the first results in the second processing mode to obtain the final result of the target task when there are more than two different first results.

In some embodiments, when processing the first results in the first processing mode to obtain the final result of the target task, the processing unit 603 may be configured to use the first intelligent agent to process the first result output by the second intelligent agent to obtain a secondary task of the first intelligent agent, and use the second intelligent agent to process the first result output by the first intelligent agent to obtain a secondary task of the second intelligent agent, the first intelligent agent and the second intelligent agent being any two intelligent agents whose first results are different. In addition, the processing unit 603 may be further configured to use the second intelligent agent to process the secondary task of the first intelligent agent to obtain the secondary result of the second intelligent agent; use the first intelligent agent to process the secondary result of the second intelligent agent and the first results to obtain the second result of the first intelligent agent; use the first intelligent agent to process the secondary task of the second intelligent agent to obtain the secondary result of the first intelligent agent; use the second intelligent agent to process the secondary result of the first intelligent agent and the first results to obtain the second result of the second intelligent agent; determine the final result of the target task based on the second result of the first intelligent agent and the second result of the second intelligent agent.

In some embodiments, when processing the first results in the second processing mode to obtain the final result of the target task, the processing unit 603 may be configured to, for each intelligent agent, use the intelligent agent to process the first results to obtain the second result of the intelligent agent, and determine the final result of the target task based on the second results.

In some embodiments, the processing unit 603 may be further configured to obtain the benchmark results corresponding to the target task, and determine the instruction information based on the benchmark result and the final result, the instruction information being used to instruct the intelligent agents to process the next target task.

In some embodiments, the processing unit 603 may be further configured to classify multiple pieces of instruction information into multiple categories, and process each category of instruction information separately to obtain a instruction information summary corresponding to each category, the instruction information summary being used to instruct the intelligent agents to process the next target task belonging to the corresponding category.

In some embodiments, when determining the plurality of first results with different processing capabilities based on the target task, the determination unit 602 may be configured to divide the target task into a plurality of subtasks and determine a plurality of intelligent agents whose processing capabilities match the subtasks, or identify a plurality of roles related to the target task and determine a plurality of intelligent agents with corresponding processing capabilities and matching role.

In some embodiments, when using the plurality of intelligent agents to process the target task to obtain the plurality of first results, the processing unit 603 may be configured to obtain the task instruction information corresponding to the target task, and input the task instruction information and the task data of the target task into each intelligent agent to obtain the first result output by each intelligent agent.

For the working principle of the task processing device provided in the embodiments of the present disclosure, reference can be made to the relevant steps of the task processing method provided in any embodiment of the present disclosure, and will not be repeated here.

It should be noted that the various embodiments in the present specification are described in a progressive manner, and each embodiment focuses on differences from other embodiments, and the same similar parts between the various embodiments can be referred to each other.

For the convenience of description, when describing the above system or device, the function is divided into various modules or units and described separately. Of course, when implementing the embodiments of the present disclosure, the function of each unit may be implemented in the same or multiple software and/or hardware.

Based on the description of the foregoing implementation manners, those skilled in the art may clearly understand that the present disclosure may be implemented in a manner of software plus a general hardware platform. Based on this understanding, part or all of the technical solutions of the disclosure may be embodied in the form of computer program stored in a non-transitory computer-readable storage medium, which can be sold or used as a standalone product. The computer program can include instructions that enable a computer (such as a personal computer, a server, or a network device) to perform part or all of a method consistent with the disclosure. The storage medium can be any medium that can store program codes, for example, a read-only memory (ROM), a random-access memory (RAM), a magnetic disk, a compact disc read-only memory (CD-ROM), etc.

The terms “first,” “second,” “third,” “fourth,” or the like in the specification are merely used to distinguish an entity or an operation from another entity or operation, and are not intended to require or indicate that there is any such physical relationship or sequence between these entities or operations. Moreover, the term “include” or any other variants thereof are intended to cover non-exclusive inclusion. Thus, a process, method, article, or device including a series of elements not only includes those elements, but also includes any other elements that are not explicitly listed, or also includes elements inherent to the process, method, article, or device. Unless otherwise defined, the element defined by the sentence “including a . . . ” does not exclude the existence of any other identical elements in the process, method, article, or device including the element.

The embodiments disclosed herein are merely examples. Other applications, advantages, alternations, or modifications of, or equivalents to the disclosed embodiments are obvious to a person skilled in the art and are intended to be encompassed within the scope of the present disclosure.

What is claimed is:

1. A task processing method comprising:
obtaining a target task;
determining a plurality of intelligent agents with different processing capabilities based on the target task;
using the plurality of intelligent agents to process the target task to obtain a plurality of first results, each intelligent agent outputting a first result; and
processing the plurality of first results in a first processing mode or a second processing mode based on a number of different first results to obtain a final result of the target task.

2. The method of claim 1, wherein processing the plurality of first results in the first processing mode or the second processing mode based on the number of different first results to obtain the final result of the target task includes:
processing the plurality of first results in the first processing mode or the second processing mode multiple times based on the number of different first results until the final result of the target task that meets a convergence condition is obtained.

3. The method of claim 1, wherein processing the plurality of first results in the first processing mode or the second processing mode based on the number of different first results to obtain the final result of the target task includes:
processing the plurality of first results in the first processing mode to obtain the final result of the target task if there are two different first results; and
processing the plurality of first results in the second processing mode to obtain the final result of the target task if there are more than two different first results.

4. The method of claim 3, wherein processing the plurality of first results in the first processing mode to obtain the final result of the target task includes:
using a first intelligent agent to process the first result output by a second intelligent agent to obtain a secondary task of the first intelligent agent, using the second intelligent agent to process the first result output by the first intelligent agent to obtain a secondary task of the second intelligent agent, the first intelligent agent and the second intelligent agent being any two intelligent agents whose first results are different;
using the second intelligent agent to process the secondary task of the first intelligent agent to obtain a secondary result of the second agent;
using the first intelligent agent to process the secondary result of the second intelligent agent and the plurality of first results to obtain a second result of the first intelligent agent;
using the first intelligent agent to process the secondary task of the second intelligent agent to obtain a secondary result of the first intelligent agent;
using the second intelligent agent to process the secondary result of the first intelligent agent and the plurality of first results to obtain a second result of the second intelligent agent; and
determining the final result of the target task based on the second result of the first intelligent agent and the second result of the second intelligent agent.

5. The method of claim 3, wherein processing the plurality of first results in the second processing mode to obtain the final result of the target task includes:
for each of the intelligent agents, using the intelligent agent to process the plurality of first results to obtain the second result of the intelligent agent; and
determining the final result of the target task based on the plurality of second results.

6. The method of claim 1 further comprising:
obtaining a benchmark result corresponding to the target task; and
determining instruction information based on the benchmark result and the final result, the instruction information being used to instruct the intelligent agents to process the next target task.

7. The method of claim 6 further comprising:
classifying multiple pieces of instruction information into a plurality of categories; and
processing the instruction information of each category separately to obtain an instruction information summary corresponding to each category, the instruction information summary being used to instruct the intelligent agents to process the next target task belonging to the corresponding category.

8. The method of claim 1, wherein determining the plurality of intelligent agents with different processing capabilities based on the target task includes:
dividing the target task into a plurality of subtasks, and determining the plurality of intelligent agents whose corresponding processing capabilities match the subtasks; or,
determining a plurality of roles related to the target task, and determining the plurality of intelligent agents whose corresponding processing capabilities match the roles.

9. The method of claim 1, wherein using the plurality of intelligent agents to process the target task to obtain the plurality of first results includes:
obtaining task instruction information corresponding to the target task; and
inputting the task instruction information and task data of the target task into each of the intelligent agents to obtain the first result output by each of the intelligent agents.

10. An electronic device comprising:
one or more processors; and
one or more memories coupled to the one or more processors and storing a plurality of computer instructions that, when being executed, cause the one or more processors to perform:
obtaining a target task;
determining a plurality of intelligent agents with different processing capabilities based on the target task;
using the plurality of intelligent agents to process the target task to obtain a plurality of first results, each intelligent agent outputting a first result; and
processing the plurality of first results in a first processing mode or a second processing mode based on a number of different first results to obtain a final result of the target task.

11. The electronic device of claim 10, wherein the one or more processors are further configured to perform:
processing the plurality of first results in the first processing mode or the second processing mode multiple times based on the number of different first results until the final result of the target task that meets a convergence condition is obtained.

12. The electronic device of claim 10, wherein the one or more processors are further configured to perform:
processing the plurality of first results in the first processing mode to obtain the final result of the target task if there are two different first results; and
processing the plurality of first results in the second processing mode to obtain the final result of the target task if there are more than two different first results.

13. The electronic device of claim 12, wherein the one or more processors are further configured to perform:
using a first intelligent agent to process the first result output by a second intelligent agent to obtain a secondary task of the first intelligent agent, using the second intelligent agent to process the first result output by the first intelligent agent to obtain a secondary task of the second intelligent agent, the first intelligent agent and the second intelligent agent being any two intelligent agents whose first results are different;
using the second intelligent agent to process the secondary task of the first intelligent agent to obtain a secondary result of the second agent;
using the first intelligent agent to process the secondary result of the second intelligent agent and the plurality of first results to obtain a second result of the first intelligent agent;
using the first intelligent agent to process the secondary task of the second intelligent agent to obtain a secondary result of the first intelligent agent;
using the second intelligent agent to process the secondary result of the first intelligent agent and the plurality of first results to obtain a second result of the second intelligent agent; and
determining the final result of the target task based on the second result of the first intelligent agent and the second result of the second intelligent agent.

14. The electronic device of claim 12, wherein the one or more processors are further configured to perform:
for each of the intelligent agents, using the intelligent agent to process the plurality of first results to obtain the second result of the intelligent agent; and
determining the final result of the target task based on the plurality of second results.

15. The electronic device of claim 10, wherein the one or more processors are further configured to perform:
obtaining a benchmark result corresponding to the target task; and
determining instruction information based on the benchmark result and the final result, the instruction information being used to instruct the intelligent agents to process the next target task.

16. The electronic device of claim 15, wherein the one or more processors are further configured to perform:
classifying multiple pieces of instruction information into a plurality of categories; and
processing the instruction information of each category separately to obtain an instruction information summary corresponding to each category, the instruction information summary being used to instruct the intelligent agents to process the next target task belonging to the corresponding category.

17. The electronic device of claim 10, wherein the one or more processors are further configured to perform:
dividing the target task into a plurality of subtasks, and determining the plurality of intelligent agents whose corresponding processing capabilities match the subtasks; or,
determining a plurality of roles related to the target task, and determining the plurality of intelligent agents whose corresponding processing capabilities match the roles.

18. The electronic device of claim 10, wherein the one or more processors are further configured to perform:
obtaining task instruction information corresponding to the target task; and
inputting the task instruction information and task data of the target task into each of the intelligent agents to obtain the first result output by each of the intelligent agents.

19. A non-transitory computer readable storage medium containing computer instructions that, when being executed, cause at least one processor to perform:
obtaining a target task;
determining a plurality of intelligent agents with different processing capabilities based on the target task;
using the plurality of intelligent agents to process the target task to obtain a plurality of first results, each intelligent agent outputting a first result; and
processing the plurality of first results in a first processing mode or a second processing mode based on a number of different first results to obtain a final result of the target task.

20. The storage medium of claim 19, wherein the at least one processor is further configured to perform:
processing the plurality of first results in the first processing mode or the second processing mode multiple times based on the number of different first results until the final result of the target task that meets a convergence condition is obtained.
